(19) United States
(12) Patent Application Publication
(10) Pub. No.: US 2003/0043407 A1
(43) Pub. Date: Mar. 6, 2003

(54) Printer control system having print thickness control function and method thereof

(76) Inventor: Young-soo Han, Gyeonggi-do (KR)

Correspondence Address: STAAS & HALSEY LLP, 700 11TH STREET, NW, SUITE 500, WASHINGTON, DC, 20001, US

(21) Appl. No.: 10/115,423

(22) Filed: Apr. 4, 2002

(30) Foreign Application Priority Data
Aug. 28, 2001 (KR) 2001-52108

(51) Int. Cl. B41F 1/00; G06F 15/00

(52) U.S. Cl. 358/1.15; 358/1.9; 358/1.11

(57) ABSTRACT

A printer control system for and a printer control method of controlling a print option, such as a line or text thickness value include generating an information registration window that enables a user to configure the print option, designating the line/text thickness in the information registration window, reconfiguring the line/text thickness of the print option after combining an original line/text thickness value designated by an application program unit with the designated line/text thickness value designated in the information registration window in response to a print command, and printing printer data based on the reconfigured print option.

### CROSS-REFERENCE TO RELATED APPLICATIONS

This application claims the benefit of Korean No. 2001-52108, filed Aug. 28, 2001, in the Korean Industrial Property office, the disclosure of which is incorporated herein by reference.

### BACKGROUND OF THE INVENTION

1. Field of the Invention

The present invention relates to a printer control system for printing a document displayed on a Personal Computer (PC) monitor in accordance with a controlled line or text thickness, and more particularly, to a printer control system for controlling a print thickness of a line or text and a printer control method thereof.

2. Description of the Related Art

As an office device, a printer connected to a computer is used to print data, such as document data or image data, on paper. The printer receives the print data prepared or edited by the computer, converts the print data into a suitable print image and prints the print image corresponding to the print data on paper using color dye, such as ink or toner.

FIG. 1 shows a method of printing a document using the printer. As shown in FIG. 1, an application program unit generates a print command in operation 110 and transmits predefined document configuration information, such as line/text thickness or size information, to a printer driver (not shown) in operation 120.

The printer driver reads the pre-defined document configuration information received from the application program unit in operation 130 and generates print data in operation 140.

The print command is sent to the printer in order to print the print data in operation 150.

As described above, the conventional printer driver reads the pre-defined document configuration information about the line/text thickness designated by the application program unit and generates the print data suitable for the printer. However, if the document is printed based on the pre-defined document configuration information pre-designated by the application program unit, it is difficult to print the document with a minute line, such as a one-dot line, due to characteristics of a cartridge of the printer. In addition, insufficient toner within the cartridge causes a printed character to be faint, and faulty processing of the line/text thickness in the application program unit may cause the printed line/text to be overlapped because the line/text thickness is set to be too thick.

### SUMMARY OF THE INVENTION

To solve the above-described problems, it is an object of the present invention to provide a printer control method enabling a user to easily change the line/text thickness in a printer driver.

It is another object of the present invention to provide a printer control system where the above printer control method is applied.

Additional objects and advantageous of the invention will be set forth in part in the description which follows and, in part, will be obvious from the description, or may be learned by practice of the invention.

To achieve the above and other objects, a printer driver control method according to the present invention is provided to include generating an information registration window that enables a user to configure a print option, receiving a user line/text thickness of the print options through the information registration window, reconfiguring the print option including the line/text thickness after combining an original line/text thickness value designated by the application program unit with the user line/text thickness input through the information registration window in response to a print command generated from the application program unit, and printing an image corresponding to print data based on the reconfigured print option.

To achieve the above and other objects, a printer control system according to the present invention is provided to include an application program unit preparing a document and designating a print option including an original line/text thickness, and a printer driver generating an information registration window, receiving a user line/text thickness input through the information registration window and reconfiguring the print option after combining the original line/text thickness value designated by the application program with the user line/text thickness input through the registration information window, and a printer printing the document prepared by the printer driver according to the reconfigured print option.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 is a flow diagram showing a conventional printer control method of printing a document;

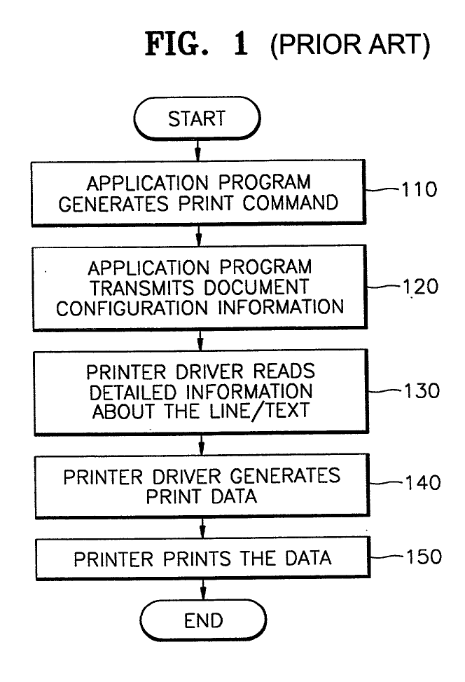

FIG. 2 is a block diagram of a printer control system that has a print thickness control function according to an embodiment of the present invention;

FIG. 3 is a flow diagram showing a print control method of controlling the print thickness control function in the printer control system of FIG. 2.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described in order to explain the present invention by referring to the figures.

An embodiment of the present invention will be described with reference to the attached drawings.

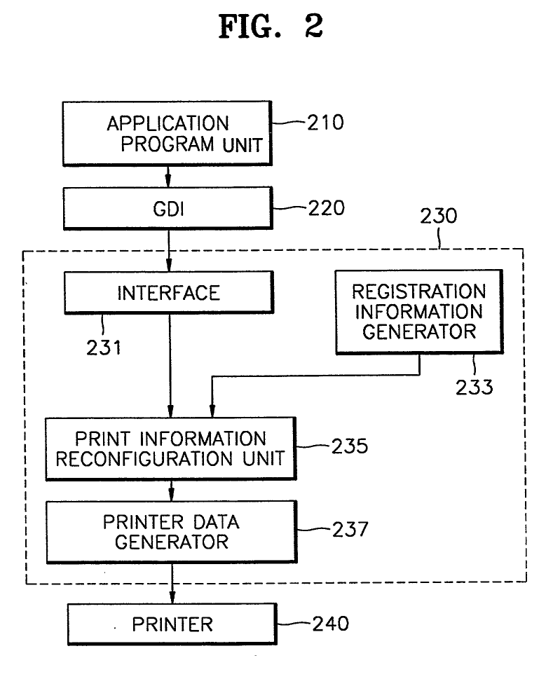

FIG. 2 is a block diagram of a printer control system that has a print thickness control function.

As shown in FIG. 2, an application program unit 210 enables a user to perform a specific document task on a computer. The application program unit 210 generates a print command to process data, such as font data, graphic data or image data, depending on the designated specific document task, and designates document configuration information, such as print option data including an original line/text thickness value and size value of a print image corresponding to print data to be printed in accordance with the print option data using ink or toner.

The line or text thickness means a thickness of a minimum line or a single dot in the print image corresponding to the print data. The line or text size means a length of the minimum line or the single dot in the print image corresponding to the print data. The thickness is measured in a parallel direction to a paper feeding direction while the size is measured in a perpendicular direction to the paper feeding direction.

A Graphic Device Interface (GDI) 220 interfaces graphic-related data to process the graphic data between the application program unit 210 and a printer driver 230.

The printer driver 230 creates an information registration window that enables a user to set the print option, such as the line/text thickness, and reconfigures the document configuration information after combining the original line/text thickness designated by the application program unit 210 with a user line/text thickness input by the user when creating the print data.

A printer 240 receives a graphic-related command transmitted by the printer driver 230 and prints the print data at a resolution such as 600 dpi or 1200 dpi.

The printer driver 230 will now be described in more detail.

An interface unit 231 receives the document configuration information and graphic-related data from the GDI 220.

The registration information generator 233 creates an information registration window, such as a user interface, where the user can set or modify the document configuration information and input the user line/text thickness through the information registration window.

A print information reconfiguration unit 235 reconfigures the document configuration information after combining the user line/text thickness received through the registration information generator 233 with the original line/text thickness designated by the application program unit 210.

A printer data generator 237 generates the printer data using the reconfigured document configuration information reconfigured by the print information reconfiguration unit 235.

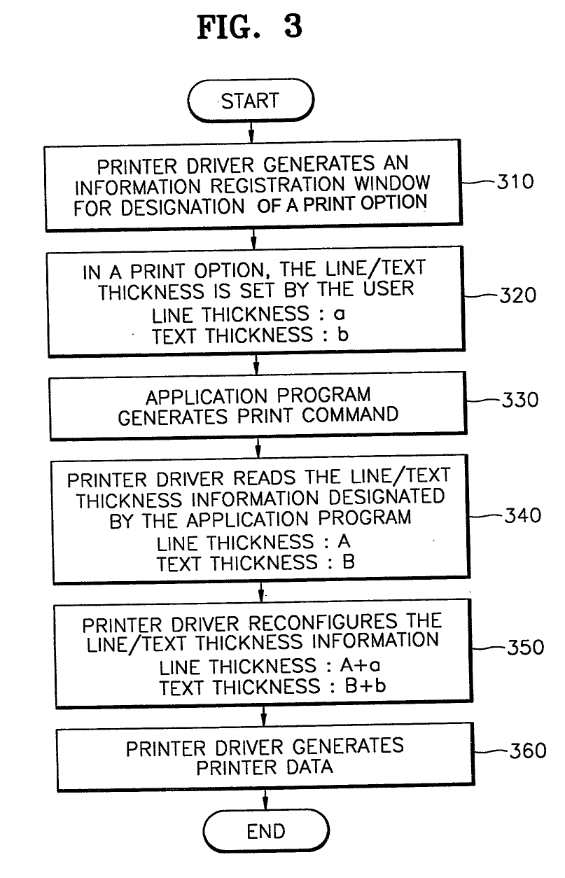

FIG. 3 is a flow diagram showing a print control method of controlling the print option including the line/text thickness, size, font, space, etc., according to the print control system of FIG. 2.

The printer driver 230 generates an information registration window designating the print option in operation 310.

In the information registration window, the line/text thickness is set or modified by the user. For example, the line thickness is set or modified to “a” and the text thickness is set or modified to “b” in operation 320.

Then, the application program unit 210 generates a command to print the document in operation 330. In the application program unit 210, the original line/text thickness of the print option is designated.

The printer driver 230 reads the document configuration information of the document pre-defined in the application program unit 210 in operation 340. For example, the original line thickness read by the application program unit 210 is A, and the original text thickness is “B”.

The printer driver 230 reconfigures the document configuration information after combining the original line/text thickness designated by the application program unit 210 with the user line/text thickness designated by the user in operation 350. For example, the printer driver 230 reconfigures the line thickness as A+a and the text thickness as B+b. The original line thickness “A” and the original text thickness “B” may be replaced with the modified line thickness “a” and the modified text thickness “b.”

Then, the printer driver 230 generates the printer data using the reconfigured document configuration information in operation 360.

While this invention has been particularly shown and described with reference to preferred embodiments thereof, it will be understood by those skilled in the art that various changes in form and details may be made therein without departing from the spirit and scope of the invention as defined by the appended claims.

As described above, according to the present invention, when a user wishes to print minute lines such as a one-dot line, when a printed line overlaps with other lines, or when the thickness of text is not uniform and causes inconvenience to the user, the printer control system enables the user to designate document information such as the line/text thickness and enhance the printing quality of the line/text.

Although a few preferred embodiments of the present invention have been shown and described, it would be appreciated by those skilled in the art that changes may be made in this embodiment without departing from the principles and sprit of the invention, the scope of which is defined in the claims and their equivalents.

What is claimed is:

1. A printer driver control method comprising:
generating an information registration window enabling a user to input a print option;
receiving a user line/text thickness value of the print option input through the registration information window;
combining an original line/text thickness value designated by an application program unit with the user line/text thickness value received through the registration information window;
reconfiguring the print option in accordance with the combination and generating print data in response to a print command; and
printing a print image corresponding to the printer data based on the reconfigured print option.

2. A printer control system comprising:
an application program unit preparing a document and designating original line/text thickness value of print option data;
a printer driver generating a registration information window, receiving a user line/text thickness input through the registration information window, combining the original line/text thickness value designated by the application program unit with the user line/text thickness value input through the registration information window, and reconfiguring a new line/text thickness of the print option data in accordance with the combination; and
a printer printing the document prepared by the printer driver according to the reconfigured line/text thickness value of the print option data.

3. The printer control system of claim 2, wherein the printer driver comprises:
an information registration generator creating the registration information window, where a user inputs the user line/text thickness; and
a print information reconfiguration unit reconfiguring the print option data and generating the new line/text thickness in response to the user line/text thickness input through the information registration generator.

4. A printer control system, comprising:
an application program unit generating a print command and configuration information including an original line thickness;
a printer driver generating an information registration window enabling a user to input a user line thickness, combining the original line thickness received from the application program unit and the user line thickness input through the information registration window, reconfiguring the configuration information in response to the combination of the original line thickness and the user line thickness, and generating print data in accordance with the reconfigured configuration information, the print data representing a print image.

5. The printer control system of claim 4, wherein the print data is document print data, and the configuration information is document configuration information.

6. The printer control system of claim 4, wherein the user line thickness includes a thickness of a minimum line or a single dot in the print image corresponding to the print data, the thickness measured in a parallel direction to a paper feeding direction.

7. The printer control system of claim 4, wherein the user line thickness includes a length of a minimum line or a single dot in a print image corresponding to the print data, the length measured in a perpendicular direction to a paper feeding direction.

8. The printer control system of claim 4, wherein information registration window is automatically generated in response to the print command.

9. The printer control system of claim 4, further comprising a printer printing an image corresponding to the print data in response to the print command and the reconfigured configuration information.

10. A printer control system, comprising:
an application program unit generating a print command and first print option data; and
a printer driver generating a window showing the first print option data in response to the print command, receiving second print option data through the window, calculating third print option data in accordance with a combination of the first printing option data and the second print option data, and generating print data representing a print image to be printed on paper in response to the third print option data and the print command.

11. The printer control system of claim 10, wherein the print data includes one of a line and a text, and the first, second, and third print option data represent a thickness value of the one of the line and the text of the print data.

12. The printer control system of claim 10, wherein the first print option data includes an original line thickness or an original line size of the image, and the second print option data includes one of a modified line thickness and a modified line size.

13. The printer control system of claim 10, wherein the window includes the second print option data.

14. The printer control system of claim 10, wherein the window is automatically generated in response to the print command.

15. The printer control system of claim 10, further comprising a graphic device interfacing graphic-related data corresponding to graphic data of the print data between the application program unit and the printer driver.

16. The printer control system of claim 10, wherein the printer driver comprises a registration information generator automatically generating the window enabling a user to input the second print option data.

17. The printer control system of claim 10, wherein the second print option data is different from the first print option data in amount.

18. The printer control system of claim 10, wherein the third print option data is different from the first and second print option data.

19. The printer control system of claim 10, wherein the first print option data is an original line thickness value of the print data transmitted from the application program unit, and the second print option data is a user line thickness value transmitted outside the print driver other than the application program unit.

20. The printer control system of claim 19, wherein the original line thickness value is different from the user line thickness value.

21. The printer control system of claim 19, wherein the third print option data is a sum of the original line thickness value and the user line thickness value.

22. The printer control system of claim 10, wherein the printer driver generates a graphic-related command in response to the print data to generate the print image.

23. The printer control system of claim 22, further comprising a printer printing the print image corresponding to the print data in response to the graphic-related command.

24. The printer control system of claims 10, wherein the printer driver comprises:
an interface unit receives the first print option data and graphic-related data from the application program unit;
a registration information generator generating the window and receiving the second print option data input through the information registration window; and
a print information reconfiguration unit combining the first print option data and the second print option data and generating the third print option data.

25. The printer control system of claims 10, wherein the printer driver does not generate the print data in an absence of the user print option data.

26. A printer control method comprising:
generating a print command and first print option data; and
automatically generating a window in response to the print command;
receiving second print option data through the window;
calculating third print option data in accordance with the first printing option data and the second print option data; and
generating print data representing a print image to be printed on paper in response to the third print option data and the print command.

27. The printer control method of claim 26, wherein the print data includes one of a line and a text, and the first, second, and third print option data represent a thickness value of one of the line and the text of the print data.

28. The printer control system of claim 26, wherein the first print option data includes one of an original line thickness and an original line size of the print image, and the second print option data includes one of a user line thickness and a user line size of the print image.

29. The printer control system of claim 26, wherein the third print option data is a sum of the first print option data and the second print option data.
